(19) United States
(12) Patent Application Publication
(10) Pub. No.: US 2021/0065695 A1
(43) Pub. Date: Mar. 4, 2021

(54) PROGRAM STORAGE MEDIUM, METHOD, AND APPARATUS FOR DETERMINING POINT AT WHICH TREND OF CONVERSATION CHANGED

(71) Applicant: FUJITSU LIMITED, Kawasaki-shi (JP)

(72) Inventor: Keigo MOTOSUGI, Nagano (JP)

(73) Assignee: FUJITSU LIMITED, Kawasaki-shi (JP)

(21) Appl. No.: 17/004,045

(22) Filed: Aug. 27, 2020

(30) Foreign Application Priority Data
Aug. 30, 2019 (JP) 2019-158026

(51) Int. Cl. G10L 15/18; G10L 25/48; G10L 15/26; G10L 25/45

(52) U.S. Cl. CPC G10L 15/1815; G10L 25/45; G10L 15/26; G10L 25/48

(57) ABSTRACT

A program causes a computer to execute a process for determining points at which the trend of conversation changed. The process includes: obtaining conversation data indicating the content that users spoke in a specified period of time; and determining a point at which the trend of conversation changed in the specified period, based on at least one of the following information items: information on the number of uttered words or characters, information on the number of speakers, and information on the frequency of utterances of positive words or negative words, determined for each unit time based on the obtained conversation data.

### CROSS-REFERENCE TO RELATED APPLICATION

This application is based upon and claims the benefit of priority of the prior Japanese Patent Application No. 2019-158026, filed on Aug. 30, 2019, the entire contents of which are incorporated herein by reference.

### FIELD

The present disclosure relates to an information processing program storage medium, an information processing method, and an information processing apparatus for determining points at which the trend of conversation changed.

### BACKGROUND

There has been a technique for generating a summary from text data of a document (for example, an article, a monograph) using a summarization algorithm such as LexRank. LexRank is an extraction-based summarization algorithm that extracts representative sentences from a document. There has also been a technique for converting inputted voice data into text data.

As a related art, there is one in which voice signals obtained through a voice input unit are converted into feature parameters; the feature parameters are recognized as a phoneme symbol sequence; important sections reflecting the subjects of conversation are selected using the phoneme symbol sequence; subject boundaries are detected using the distribution of appearances of the important sections; the important sections included in each subject section are semantically classified; and subject information is generated and outputted.

There is also a technique in which a voice section including points specified by an important-point instruction unit is recognized, out of the voices inputted through a voice input unit, as a section for which a summary is desired; an appropriate section is estimated by an important-section estimation unit; voice recognition is performed on voices in consideration of the important section; and a summary is generated from the text.

There is also a technique in which elapsed time periods including voice parts in voice information, matching feature patterns held in a feature-pattern holding unit are determined; words are recognized from the voice information; the recognized words and the elapsed time periods including the recognized words are stored; voice parts matching feature patterns are associated with words based on the both types of elapsed time periods; and a summary is generated from the voice information using those words.

Related techniques are disclosed in, for example, Japanese Laid-open Patent Publication Nos. 2000-284793 and 2006-58567 and International Publication Pamphlet No. WO 2008/050649.

### SUMMARY

According to an aspect of the embodiments, a program causes a computer to execute a process for determining points at which the trend of conversation changed. The process includes: obtaining conversation data indicating the content that users spoke in a specified period of time; and determining a point at which the trend of conversation changed in the specified period, based on at least one of the following information items: information on the number of uttered words or characters, information on the number of speakers, and information on the frequency of utterances of positive words or negative words, determined for each unit time based on the obtained conversation data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of the system configuration of a summary processing system;

FIG. 3 is an explanatory diagram illustrating a screen example of message screens;

FIG. 4 is a block diagram illustrating an example of the hardware configuration of a summary processing apparatus;

FIG. 5 is a block diagram illustrating an example of the hardware configuration of a terminal;

FIG. 6 is an explanatory diagram illustrating an example of the data structure of message data;

FIG. 7 is an explanatory diagram illustrating an example of the memory contents of a message DB;

FIG. 8 is an explanatory diagram illustrating an example of the memory contents of a score table;

FIG. 9 is a block diagram illustrating an example of the functional configuration of the summary processing apparatus;

FIG. 10 is an explanatory diagram (part 1) illustrating a specific example of message data pieces for each unit time;

FIG. 11 is an explanatory diagram (part 2) illustrating a specific example of message data pieces for each unit time;

FIG. 12 is an explanatory diagram illustrating a specific example of a graph illustrating the change over time in a conversation score;

FIG. 13 is an explanatory diagram illustrating an example of the memory contents of a slope table;

FIG. 14 is an explanatory diagram illustrating an example of the memory contents of an appearance frequency table;

FIG. 15 is an explanatory diagram illustrating an example of determining points at which the trend of conversation changed;

FIG. 16 is an explanatory diagram (part 1) illustrating an example of a conversation list screen;

FIG. 17 is an explanatory diagram (part 2) illustrating an example of a conversation list screen;

FIG. 18 is an explanatory diagram (part 3) illustrating an example of a conversation list screen;

FIG. 19 is a flowchart illustrating an example of message processing procedure in the terminal;

FIG. 20 is a flowchart illustrating an example of message-registration processing procedure in the summary processing apparatus;

FIG. 21 is a flowchart (part 1) illustrating an example of summary-generation processing procedure in the summary processing apparatus;

FIG. 22 is a flowchart (part 2) illustrating an example of summary-generation processing procedure in the summary processing apparatus; and

FIG. 23 is a flowchart illustrating an example of processing procedure for displaying messages in list form in the summary processing apparatus.

### DESCRIPTION OF EMBODIMENTS

Unfortunately, in the related conventional techniques, it is difficult to determine points in a conference or the like at which the subject changed, or the discussion became active, and thus which are regarded as points at which the trend of conversation changed.

In one aspect, an object of the present disclosure is to determine points at which the trend of conversation changed.

Hereinafter, an embodiment of an information processing program, an information processing method, and an information processing apparatus according to the present disclosure is described in detail with reference to the drawings.

### Embodiment

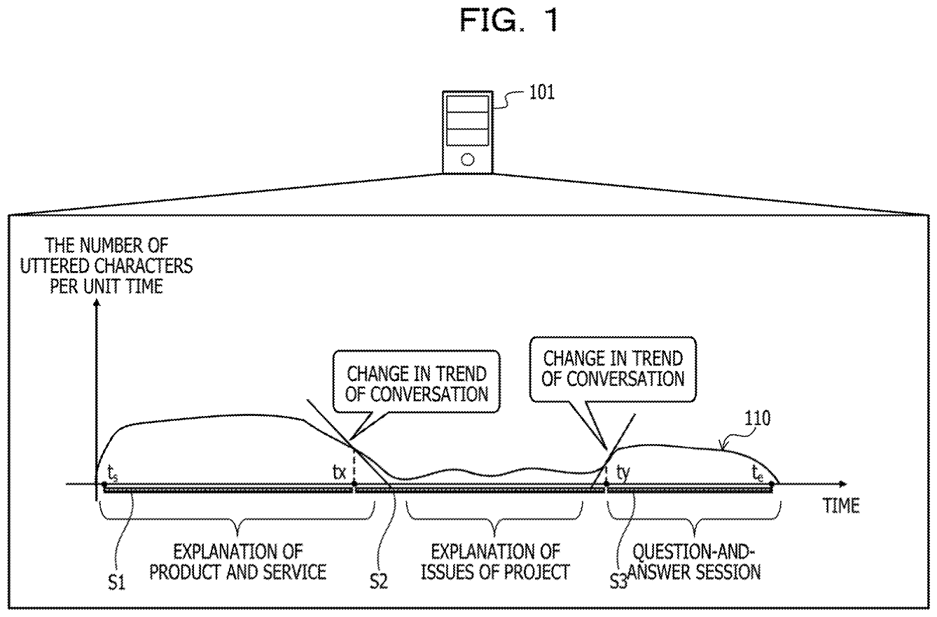

FIG. 1 is an explanatory diagram illustrating an example of an information processing method according to the embodiment. In FIG. 1, an information processing apparatus 101 is a computer that determines points at which the trend of conversation changed. Conversation means multiple users talking with one another by expressing intention such as making voice and inputting text. Conversation may include a single user speaking alone. Examples of situations in which conversation takes place include conferences, meetings, and speeches.

There are cases in which voice data or the like recorded during a conference is converted into text and a summary in which the content of the conversation is summarized is generated from the text data. Examples of summarization algorithms include an extraction-based summarization algorithm called LexRank. For LexRank, a sentence similar to many sentences is regarded as an important sentence, a sentence similar to an important sentence is regarded as an important sentence, and representative sentences are extracted as a summary.

Meanwhile, there are cases in which multiple subjects are discussed in one conference. During a conference, there are time periods in which the discussion is lively, and there are also time periods in which the discussion is inactive. For this reason, a summarization algorithm such as LexRank sometimes extracts information on only part of topics in a conference and fails to extract information on the other topics.

For example, in a case where there is an explanation at the beginning of a conference and discussion follows, if there are a large number of contents during the explanation, information only on the explanation part is extracted. In a case in which a discussion about A and a discussion about B took place, and in which A was thoroughly discussed, but the discussion about B took only a short time, a summary about only A is generated in some cases.

If it is possible to determine points at which the trend of conversation changed such as when the subject changed or the discussion became active in one conference or the like, it is possible to divide the content of conversation at the points. If a summary is generated for each division part, it is possible to avoid the situation in which information on important topics is lost.

However, manually checking the content of conversation after a conference or the like finishes and determining points at which the subject changed or the discussion became active takes efforts and time. Starting a new recording when the trend of conversation changed may be conceivable, but it is often difficult to manually determine a change of the trend of conversation during a conference or the like.

Hence, described in the present embodiment is an information processing method in which points at which the trend of conversation changed are automatically determined based on conversation data indicating the content that the users spoke in a conference or a meeting. An example of processing performed by the information processing apparatus 101 is described below.

(1) The information processing apparatus 101 obtains conversation data indicating the content that the users spoke during a specified period. The specified period may be set to any period. For example, a specified period may be a period from when a conversation starts and to when the conversation finishes or a period that is part of a period during which a conversation took place.

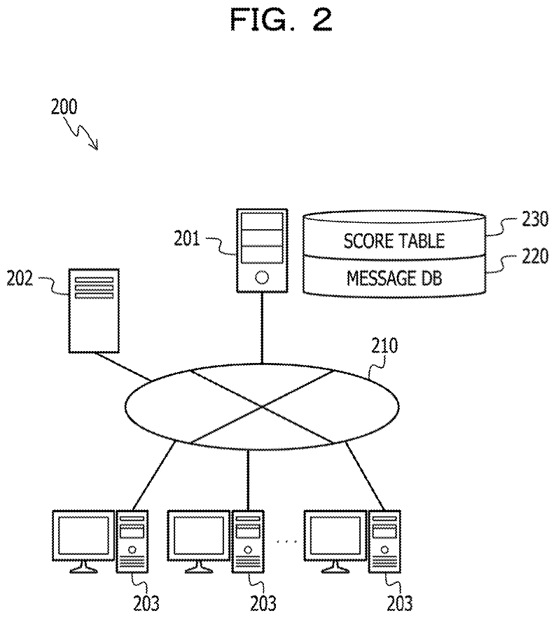

Specifically, for example, the information processing apparatus 101 obtains conversation data indicating the content that each user spoke from the terminals used by the users (for example, terminals 203 illustrated in FIG. 2). The conversation data includes text data indicating the content that the users spoke. The text data may be, for example, data into which data inputted as voice was converted or data inputted through operation of a keyboard or the like.

The conversation data includes, for example, information for identifying the users and information for determining the time when a user spoke (utterance time). Here, the information processing apparatus 101 may regard the date and time when the information processing apparatus 101 obtains conversation data from the terminal of each user as the utterance time.

(2) The information processing apparatus 101 determines points at which the trend of conversation changed in a specified period, based on at least one of the following information items: information on the number of uttered characters, information on the number of speakers, and information on the frequency of utterances of positive words or negative words for each unit time, determined based on the obtained conversation data. The unit time may be set to any time period, and for example, the unit time is set to a time of around 1 to 3 minutes.

The number of uttered characters means the number of characters included in the words that the users spoke. The number of speakers means the number of users who are speaking. The word “positive” means “affirmative”, “active”, “forward-looking”, or the like. For example, words such as “wonderful”, “happy”, and the like are examples of positive words. The word “negative” means “adverse”, “passive”, “backward-looking”, or the like. For example, words such as “dislike”, “no way”, and the like are examples of negative words.

For example, it is possible to regard a greater number of uttered characters per unit time as a state in which discussion is taking place more actively. It is possible to regard a larger number of speakers per unit time is as a state in which discussion is taking place more actively. For example, it is possible to use the change over time in the number of uttered characters or the number of speakers to determine the time when discussion became active or inactive.

It is possible to regard a higher frequency of utterances of positive words as a state in which positive opinions are more dominant. It is possible to regard a higher frequency of utterances of negative words as a state in which negative opinions are more dominant. For example, it is possible to use the change over time in the frequency of utterances of positive words and negative words to determine the time when the content of opinions changed.

Thus, the information processing apparatus 101 may determine points at which the trend of conversation changed, for example, based on at least one of the following information items: the change over time in the number of uttered characters, the change over time in the number of speakers, and the change over time in the frequency of utterances of positive words or negative words for each unit time.

More specifically, for example, the information processing apparatus 101 calculates the number of uttered characters for each unit time based on the obtained conversation data. The information processing apparatus 101 may determine the point at which the change rate over time of the calculated number of uttered characters for each unit time exceeds a threshold as the point at which the trend of conversation changed. Although it is possible to use the number of words instead of the number of characters, the following description is made for a case of the number of characters.

With this, it is possible to determine the time when the number of uttered characters per unit time changed greatly and which is thus regarded as the time when the discussion became active or inactive as the point at which the trend of conversation changed.

For example, the information processing apparatus 101 calculates the number of speakers for each unit time based on the obtained conversation data. The information processing apparatus 101 may determine the point at which the change rate over time of the calculated number of speakers for each unit time exceeds a threshold as the point at which the trend of conversation changed.

With this, it is possible to determine the time when the number of speakers for each unit time changed greatly and which is thus regarded as the time when the discussion became active or inactive as the point at which the trend of conversation changed.

For example, the information processing apparatus 101 calculates the frequency of utterances of positive (or negative) words for each unit time based on the obtained conversation data. The information processing apparatus 101 may determine the point at which the change rate over time of the calculated frequency for each unit time exceeds a threshold as the point at which the trend of conversation changed.

With this, it is possible to determine the time when the number of positive (or negative) opinions increased and which is thus regarded as the time when the mood of conversation or the subject changed as the point at which the trend of conversation changed.

The example of FIG. 1 is based on the assumption of the case of determining the points at which the trend of conversation changed in a conference in which first, products and services were explained, then, issues on projects were explained, and lastly, a question-and-answer session was held. The following description is based on an example in which the points at which the trend of conversation changed are determined based on the change over time in the number of uttered characters for each unit time. The following describes the content that each user spoke in the conference.

Explanation of Product and Service

“This program makes it possible to clarify the features of your product and service and to develop ideas that anticipate customers' potential needs, using a framework of marketing theories. Using a unique framework of our company, the program supports planning of hypotheses for the product and service in a rapid manner, based on grounds. Since we serve as a hub of organization and information for connecting different departments, it is possible, for example, for the engineering department and the business department to work together for product planning and to advance commercialization taking an advantage of technologies. It is possible to develop ideas with new concepts, taking third-party's viewpoints. Value proposition is a marketing term. It means values that customers want, that competitors are not able to provide, but that our company are able to provide. In short, it means reasons why customers buy spending their money. In an actual scene of product planning, they sometimes start with thinking about what they can provide, without having grounds for it. However, customers buy our products and services only when the customers think that they want buy them but they can't buy spending their money for them from the other companies. So, it is important to pay attention to value proposition. By advancing product planning paid attention to value proposition, you can connect the product planning to customers feelings that they want it and want to buy it, and you can make differentiation from your competitors”.

Explanation of Issues of the Project

“The software that we are currently selling has no advantage over our competitors”. It is inevitable that we will lose if we don't take any measures. Since the software uses old architecture, the development cost will be a considerable amount”.

Question-and-Answer Session

“I would really like to use this program for our project. How can I apply for it? Thank you very much. Please fill out this form and email it to the person in charge. What is the schedule from now on? I will send you detailed materials at a later date”.

In this case, the information processing apparatus 101 obtains conversation data indicating the content that each user spoke in the conference. Next, the information processing apparatus 101 calculates the number of uttered characters for each unit time based on the obtained conversation data. The information processing apparatus 101 determines points at which the change rate over time of the calculated number of uttered characters for each unit time exceeds a threshold as the points at which the trend of conversation changed.

The graph 110 represents the changeover time in the number of uttered characters per unit time in the conference. The vertical axis represents the number of uttered characters per unit time. The horizontal axis represents elapsed time. The graph 110 is an approximate curve generated from the number of uttered characters for each unit time calculated based on the conversation data. The symbol tₛ indicates the start time of the conference. The symbol tₑ indicates the end time of the conference.

In the graph 110, it is assumed that the reduction rate of the number of uttered characters per unit time at time tx exceeds the threshold. In this case, the information processing apparatus 101 determines that time tx at which the reduction rate of the number of uttered characters per unit time exceeded the threshold is a point at which the trend of conversation changed. In the graph 110, it is also assumed that the increase rate of the number of uttered characters per unit time at time ty exceeds the threshold. In this case, the information processing apparatus 101 determines that time ty at which the increase rate of the number of uttered characters per unit time exceeded the threshold is a point at which the trend of conversation changed.

With this, it is possible to determine the points at which the trend of conversation changed (time tx, time ty) in the conference. Time tx corresponds to the time at which the subject changed from “the explanation of the product and service” to “the explanation of issues on the project”. Time ty corresponds to the time at which the subject changed from “the explanation of issues on the project” to “the question-and-answer session”.

Thus, it is possible to generate summaries for all the subjects discussed in one conference, for example, by dividing the time period during which the conference took place (from the start time tₛ to the end time tₑ) at time tx and time ty into sections S1 to S3 and by generating a summary in which conversation in each of sections S1 to S3 is summarized.

For example, a summary of section S1 is generated as “This program makes it possible to clarify the features of your product and service and to develop ideas that anticipate customers' potential needs, using a framework of marketing theories. It is possible to develop ideas with new concepts, taking third-party's viewpoints. In short, it means reasons why customers buy spending their money. So, it is important to pay attention to value proposition. By advancing product planning paid attention to value proposition, you can connect the product planning to customers feelings that they want it and want to buy it, and you can make differentiation from your competitors”. Thus, the explanation of the product and service is summarized.

A summary of section S2 is generated as “The software that we are currently selling has no advantage over our competitors”. Thus, the explanation of issues on the project is summarized. A summary of section S3 is generated as “I would really like to use this program for our project. How can I apply for it?Please fill out this form and email it to the person in charge. Thus, the question-and-answer session is summarized.

In the case where one summary is generated for the entire conference without dividing the period during which the conference took place at time tx and time ty, information only on the explanation of the product and service would be extracted, and information on the other topics (subjects) would be lost. In contrast, the information processing apparatus 101 makes it possible to generate summaries corresponding to subjects of “the explanation of the product and service”, “the explanation of issues on the project”, and “the question-and-answer session”, thus making it possible to avoid the situation in which information on important topics is lost.

(Example of System Configuration of Summary Processing System 200)

The following describes an example of the system configuration of a summary processing system 200 according to the embodiment. The following description is based on a case in which the information processing apparatus 101 illustrated in FIG. 1 is applied to a summary processing apparatus 201 in the summary processing system 200. The summary processing system 200 is applied, for example, to a service that provides minutes (summary) into which the content of a conference is summarized.

FIG. 2 is an explanatory diagram illustrating an example of the system configuration of the summary processing system 200. In FIG. 2, the summary processing system 200 includes the summary processing apparatus 201, a voice-text-conversion server 202, and multiple terminals 203. In the summary processing system 200, the summary processing apparatus 201, the voice-text-conversion server 202, and the multiple terminals 203 are coupled via a wired or wireless network 210. The network 210 is, for example, a local area network (LAN), a wide area network (WAN), the Internet, or the like.

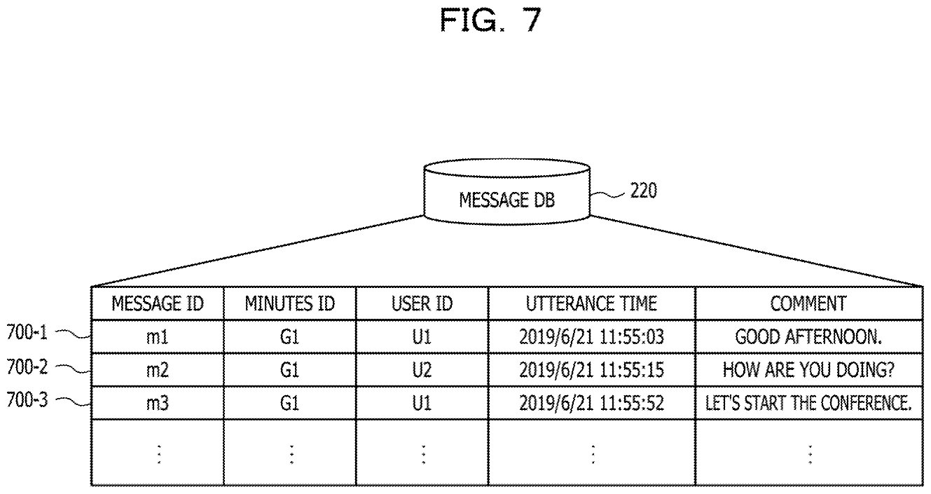

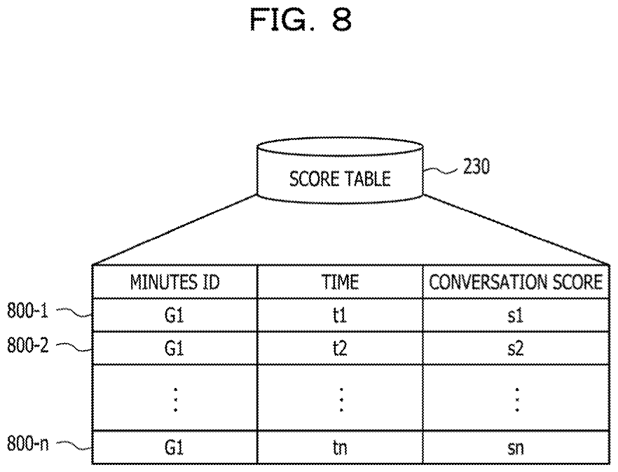

The summary processing apparatus 201 is a computer that has a message DB 220 and a score table 230 and generates summaries into which the content of conversation is summarized. The summary processing apparatus 201 is, for example, a server. The memory contents stored in the message DB 220 and the score table 230 are described later with reference to FIGS. 7 and 8.

The voice-text-conversion server 202 is a computer that converts voice data into text data. For the technique of converting voice data into text, any known technique may be used. For example, the voice-text-conversion server 202 recognizes voice from voice data using an approach based on machine learning such as deep learning and converts the voice into text (text data).

In the example of FIG. 2, the summary processing apparatus 201 and the voice-text-conversion server 202 are implemented with two separate computers, but the configuration is not limited to this example. For example, the voice-text-conversion server 202 function may be implemented in the summary processing apparatus 201.

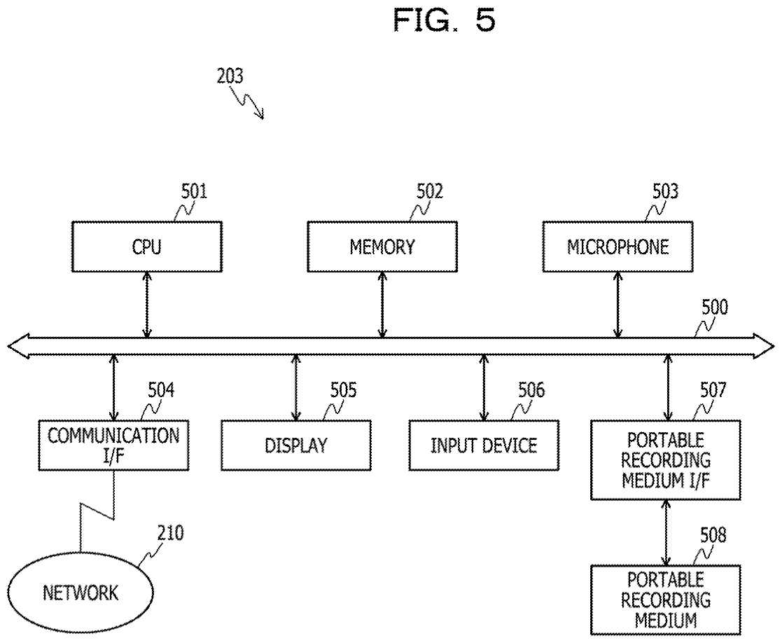

The terminal 203 is a computer with a microphone (for example, a microphone 503 illustrated in FIG. 5 described later), used by a user of the summary processing system 200. The user is, for example, a participant in a conference. The terminal 203 is, for example, a personal computer (PC), a tablet PC, a smartphone, or the like.

With the summary processing system 200, a user, for example, logs in to an application for a Web conference on the terminal 203 and is able to communicates with other users via the network 210. More specifically, for example, when the user speaks, the voice data inputted into the microphone of the terminal 203 is transmitted from the terminal 203 to the voice-text-conversion server 202.

When the voice-text-conversion server 202 receives the voice data from the terminal 203, the voice-text-conversion server 202 converts the received voice data into text data and transmits the converted text data to the terminal 203. When the terminal 203 receives the text data from the voice-text-conversion server 202, the terminal 203 transmits message data MD including the received text data to the summary processing apparatus 201.

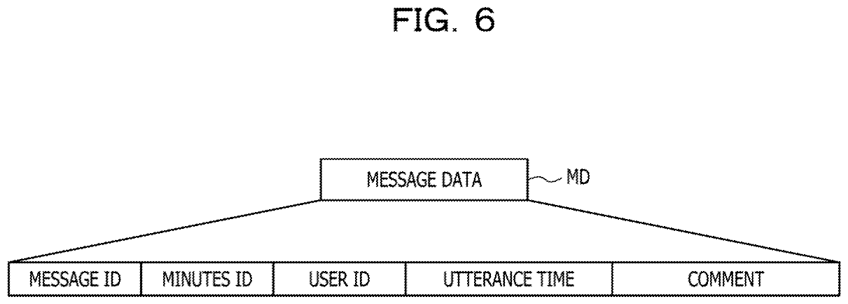

An example of the data structure of the message data MD is described later with reference to FIG. 6. Here, the content that the user remarks may be directly inputted by the user's input operation with the keyboard of the terminal 203 or the like (for example, an input device 506 illustrated in FIG. 5 described later). In this case, message data MD including text data indicating the content of a remark directly inputted by the user operation is transmitted from the terminal 203 to the summary processing apparatus 201.

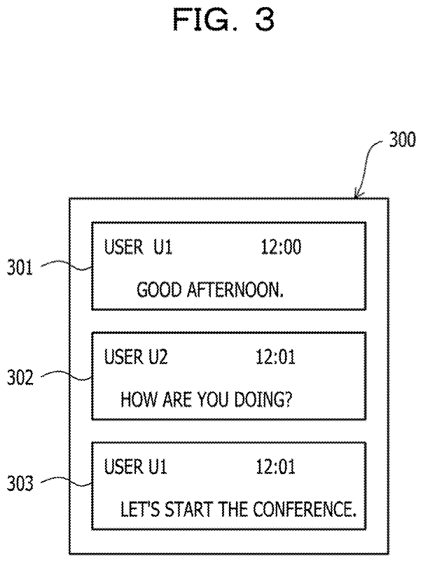

When the summary processing apparatus 201 receives the message data MD from the terminal 203, the summary processing apparatus 201 registers the received message data MD in the message DB 220. The summary processing apparatus 201 also performs rendering on the received message data MD and transmits a message (message object) to the terminals 203 of the login users (for example, the users who are attending the same conference). As a result, a message screen 300 as illustrated in FIG. 3 is displayed on the terminals 203.

FIG. 3 is an explanatory diagram illustrating a screen example of message screens. In FIG. 3, the message screen 300 is an example of a browser screen displaying message objects (for example, message objects 301 to 303) including the content remarked by each user in list form.

Each message object displays, for example, a message (comment) indicating the content of a remark made by a user and also the user ID of the user and the utterance time. On the message screen 300, message objects are displayed, for example, in chronological order from one with an earlier utterance time.

The message screen 300 allows each user to see the content of a remark that the user himself/herself made and the content of remarks that other users made, and this makes it possible, for example, for each user to communicate with other users in remote locations.

(Example of Hardware Configuration of Summary Processing Apparatus 201)

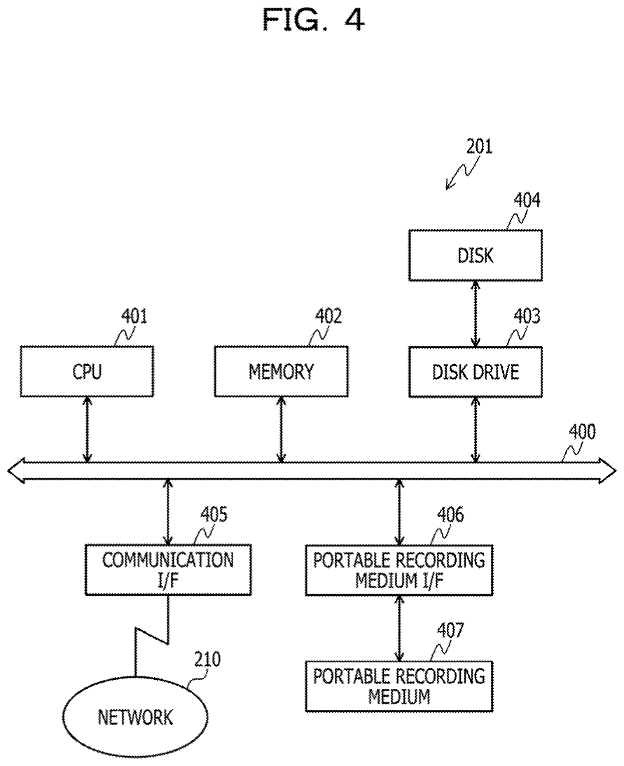

The following describes an example of the hardware configuration of the summary processing apparatus 201 with reference to FIG. 4. FIG. 4 is a block diagram illustrating an example of the hardware configuration of the summary processing apparatus 201. In FIG. 4, the summary processing apparatus 201 has a central processing unit (CPU) 401, memory 402, a disk drive 403, a disk 404, a communication interface (I/F) 405, a portable recording medium I/F 406, and a portable recording medium 407. These components are coupled to one another via a bus 400.

The CPU 401 controls the entire summary processing apparatus 201. The CPU 401 may have multiple cores. The memory 402 has, for example, read-only memory (ROM), random-access memory (RAM), flash ROM, and the like. Specifically, for example, the flash ROM stores programs of the operating system (OS), the ROM stores application programs, and the RAM is used as a work area of the CPU 401. Programs stored in the memory 402 are loaded into the CPU 401 to causes the CPU 401 to execute processing coded in the programs.

The disk drive 403 controls reading/writing of data from/to the disk 404 according to the control of the CPU 401. The disk 404 stores data written into the disk 404 under the control of the disk drive 403. Examples of the disk 404 include a magnetic disk and an optical disk.

The communication I/F 405 is coupled to the network 210 through a communication line, and via the network 210, the communication I/F 405 is coupled to external computers (for example, the voice-text-conversion server 202 and the terminals 203 illustrated in FIG. 2). The communication I/F 405 functions as an interface between the network 210 and the inside of the apparatus and controls the input and output of data from and to external computers. For example, a modem, a LAN adapter, or the like may be employed as the communication I/F 405.

The portable recording medium I/F 406 controls reading/writing of data from/to the portable recording medium 407 according to the control of the CPU 401. The portable recording medium 407 stores data written into the portable recording medium 407 under the control of the portable recording medium I/F 406. Examples of the portable recording medium 407 include a compact disc (CD)-ROM, a digital versatile disk (DVD), and a Universal Serial Bus (USB) memory.

The summary processing apparatus 201 may have, in addition to the foregoing components, for example, a solid-state drive (SSD), an input device, a display, and others. The summary processing apparatus 201 does not have to have, of the foregoing components, for example, the disk drive 403, the disk 404, the portable recording medium I/F 406, and the portable recording medium 407. The voice-text-conversion server 202 illustrated in FIG. 2 may also be implemented with the hardware configuration the same as or similar to that of the summary processing apparatus 201.

(Example of Hardware Configuration of Terminal 203)

The following describes an example of the hardware configuration of the terminal 203 with reference to FIG. 5.

FIG. 5 is a block diagram illustrating an example of the hardware configuration of the terminal 203. In FIG. 5, the terminal 203 has a CPU 501, memory 502, the microphone 503, a communication I/F 504, a display 505, the input device 506, a portable recording medium I/F 507, and a portable recording medium 508. These components are coupled to one another via a bus 500.

The CPU 501 controls the entire terminal 203. The CPU 501 may have multiple cores. The memory 502 is a storing unit having, for example, ROM, RAM, flash ROM, and the like. Specifically, for example, the flash ROM and the ROM store various programs, and the RAM is used as a work area for the CPU 501. Programs stored in the memory 502 are loaded into the CPU 501 to causes the CPU 501 to execute processing coded in the programs.

The microphone 503 is a device that converts sound into electrical signals. The sound collected by the microphone 503 is analog/digital (A/D) converted and is outputted as voice data. The microphone 503 may be, for example, of a headset type or of a tiepin type.

The communication I/F 504 is coupled to the network 210 through a communication line, and via the network 210, the communication I/F 504 is coupled to external computers (for example, the summary processing apparatus 201, the voice-text-conversion server 202). The communication I/F 504 functions as an interface between the network 210 and the inside of the apparatus and controls the input and output of data from and to external apparatuses.

The display 505 is a display device that displays data such as a cursor, icons, and a tool box, and also, documents, images, functional information, and the like. For the display 505, for example, a liquid crystal display, an organic electroluminescence (EL) display, or the like may be employed.

The input device 506 has keys for inputting characters, numbers, various instructions, and the like and is used for inputting data. The input device 506 may be a keyboard, a mouth, or the like or may be a touch-panel input pad, a numeric keypad, or the like.

The portable recording medium I/F 507 controls reading/writing of data from/to the portable recording medium 508 according to the control of the CPU 501. The portable recording medium 508 stores data written in the portable recording medium 508 under the control of the portable recording medium I/F 507.

The terminal 203 may have, in addition to the above components, for example, a hard disk drive (HDD) an SSD, a speaker, a printer, and others.

(Example of Data Structure of Message Data MD)

The following describes an example of the data structure of a message data MD piece transmitted from the terminal 203 to the summary processing apparatus 201 with reference to FIG. 6.

FIG. 6 is an explanatory diagram illustrating an example of the data structure of a message data MD piece. In FIG. 6, the message data MD piece has a message ID, a minutes ID, a user ID, an utterance time, and a comment. The message ID is an identifier for uniquely identifying a message. The minutes ID is an identifier for uniquely identifying a conference that the user participated in.

The user ID is an identifier for uniquely identifying a user. For example, the user ID is the user ID of a user who logged in to the application for a Web conference. The utterance time indicates the time when the user uttered. The comment is a message indicating the content that the user remarked. The message data MD piece does not have to include the utterance time. In this case, the summary processing apparatus 201 may determine, for example, that the time when the summary processing apparatus 201 received a message data MD piece from the terminal 203 is the utterance time.

(Memory Contents of Message DB 220)

The following describes the memory contents of the message DB 220 that the summary processing apparatus 201 has with reference to FIG. 7. The message DB 220 is, for example, implemented in the storage apparatus such as the memory 402, the disk 404, or the like illustrated in FIG. 4.

FIG. 7 is an explanatory diagram illustrating an example of the memory contents of the message DB 220. In FIG. 7, the message DB 220 has fields for the message ID, minutes ID, user ID, utterance time, and comment and stores message data pieces as records by setting information in each field (for example, message data pieces 700-1 to 700-3).

The message ID is an identifier for uniquely identifying a message. The minutes ID is an identifier for uniquely identifying a conference that the user participated in. The user ID is an identifier for uniquely identifying a user. The utterance time indicates the time when the user uttered. The comment is a message indicating the content that the user remarked.

For example, the message data piece 700-1 indicates the message ID “m1”, the minutes ID “G1”, the user ID “U1”, the utterance time “June 21, 2019 11:55:03”, and the comment “Good afternoon”.

(Memory Contents of Score Table 230)

The following describes the memory contents of the score table 230 that the summary processing apparatus 201 has with reference to FIG. 8. The score table 230 is implemented, for example, in a storage apparatus such as the memory 402, the disk 404, or the like illustrated in FIG. 4.

FIG. 8 is an explanatory diagram illustrating an example of the memory contents of the score table 230. In FIG. 8, the score table 230 has fields for the minutes ID, time, and, conversation score and stores score data pieces 800-1 to 800-n as records by setting information in each field.

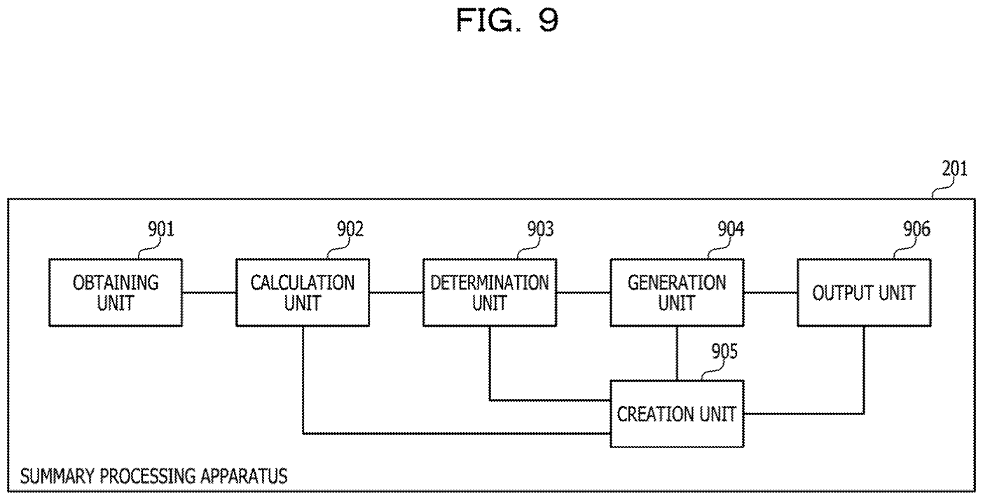

The minutes ID is an identifier for uniquely identifying a conference. The time indicates a certain time (date and time) within the period during which the conference took place. The conversation score indicates the conversation score of each time. The conversation score is an index value indicating the value of a conversation. The conversation score is described in detail later with reference to FIG. 9.

For example, the score data piece 800-1 indicates conversation score s1 at time t1 within the period during which a conference with minutes ID “G1” took place.

(Example of Functional Configuration of Summary Processing Apparatus 201)

FIG. 9 is a block diagram illustrating an example of the functional configuration of the summary processing apparatus 201. In FIG. 9, the summary processing apparatus 201 includes an obtaining unit 901, a calculation unit 902, a determination unit 903, a generation unit 904, a creation unit 905, and an output unit 906. Specifically, for example, the functions of the obtaining unit 901 to the output unit 906 are implemented by the CPU 401 executing programs stored in storage apparatuses such as the memory 402, the disk 404, and the portable recording medium 407 illustrated in FIG. 4 or by means of the communication I/F 405. The processing results of each functional unit is stored, for example, in storage apparatuses such as the memory 402 and the disk 404.

The obtaining unit 901 obtains conversation data indicating the content that the users spoke. The content that a user spoke means the content of a remark that a user made in a conference, a meeting, or the like. For example, the conversation data is message data MD having a data structure illustrated in FIG. 6. Specifically, for example, the obtaining unit 901 receives message data MD from the terminal 203 and thus obtains the received message data MD.

The obtained message data MD is, for example, registered in the message DB 220 illustrated in FIG. 7.

In the foregoing explanation, the message data MD includes the user ID of a login user, but the configuration is not limited to this example. For example, it is possible that a speaker is determined from voice data with an existing voice recognition technique. In this case, the message data MD includes the user ID of the speaker determined from the voice data. The speaker determination processing is performed, for example, in the voice-text-conversion server 202 or the terminal 203.

The calculation unit 902 calculates an index value indicating the value of a conversation for each unit time based on conversation data indicating the content that each user spoke within a specified period. The specified period may be set to any period. For example, the specified period may be a period from the start of a conference to the end of the conference or may be part of the period during which a conference took place.

Specifically, for example, the calculation unit 902 calculates a conversation score for each unit time based on at least one of the following information items: information on the number of uttered characters, information on the number of speakers, and information on the frequency of utterances of positive words or negative words for each unit time, determined based on conversation data within a specified period. The conversation score is an index value indicating the value of a conversation.

It is assumed that the specified period is the period from the start to the end of a conference. The calculation unit 902 obtains message data pieces with the same minutes ID from the message DB 220. The summary processing apparatus 201 may receive designation of a minutes ID of message data pieces to be processed. The designation of a minutes ID is made, for example, in the terminal 203. In this case, the calculation unit 902 obtains message data pieces with a designated minutes ID from the message DB 220.

Next, based on the obtained message data pieces with the same minutes ID, the calculation unit 902 calculates the number of uttered characters, the number of speakers, and a negative-positive index for each unit time. The negative-positive index is an index value indicating the frequency of utterances of positive words or negative words. More specifically, for example, from the obtained message data pieces with the same minutes ID, the calculation unit 902 determines message data pieces included in each unit time from the start to the end of the conference.

The start time of the conference is determined, for example, from the earliest utterance time among the utterance times of the message data pieces with the same minutes ID. For example, in the case where the earliest utterance time is “July 30, 2019 12:00:01”, it may be determined that “July 30, 2019 12:00:00” is the start time of the conference. The end time of the conference is determined, for example, from the latest utterance time among the utterance times of the message data pieces with the same minutes ID. For example, in the case where the latest utterance time is “July 30, 2019 12:59:12”, it may be determined that “July 30, 2019 13:00:00” is the end time of the conference.

Next, the calculation unit 902 cumulates the number of characters in the comment in every determined message data piece in each unit time to calculate the number of uttered characters for the unit time. The calculation unit 902 refers to user IDs of message data pieces in each unit time and calculates the number of user IDs avoiding duplication to calculate the number of speakers for the unit time.

The calculation unit 902 also calculates a negative-positive degree of the comment of each message data piece in each unit time by referring to a negative-positive-word dictionary. The negative-positive-word dictionary is information indicating the negative-positive degrees of words, stored being associated with those words. The negative-positive degree of a word is an index value indicating the degree of positive or negative meaning that the word has.

The negative-positive degree of a word is expressed, for example, with a value in the range from −1 (negative) to +1 (positive). The calculation unit 902 calculates the negative-positive degree of each comment by cumulating the negative-positive degrees of words included in the comment. The calculation unit 902 calculates the average value of the calculated negative-positive degrees of the comments in each unit time as the negative-positive index of the unit time.

The calculation unit 902 calculates a conversation score for each unit time based on at least one of the following information items: the number of uttered characters, the number of speakers, and the negative-positive index, calculated for each unit time. More specifically, for example, the calculation unit 902 calculates a first score based on the number of uttered characters for each unit time, a second score based on the number of speakers for each unit time, and a third score based on the negative-positive index for each unit time. The first score, the second score, and the third score are what the number of uttered characters, the number of speakers, and the negative-positive index for each unit time are modified into to make those numbers easy to use, in order to calculates a conversation score for each unit time.

In the following description, the first score based on the number of uttered characters for each unit time is sometimes referred to as the “number-of-characters score”; the second score based on the number of speakers for each unit time, the “number-of-speakers score”; and the third score based on the negative-positive index for each unit time, the “negative-positive score”.

The number-of-characters score may be determined, for example, by dividing the number of uttered characters for each unit time by the maximum number of characters per unit time. The maximum number of characters per unit time may be set to any value. For example, assuming that the unit time is “one minute”, the maximum number of characters per unit time is set to around 200 characters. The number-of-speakers score may be determined, for example, by dividing the number of speakers for each unit time by the maximum number of users. The maximum number of users corresponds, for example, to the number of participants in a conference. For the negative-positive score, the negative-positive index for each unit time may be used as it is.

The calculation unit 902 may calculate a conversation score for a unit time, for example, by summing the number-of-characters score, the number-of-speakers score, and the negative-positive score, calculated for the unit time. With this, it is possible to calculate a conversation score the value of which is higher when the number of uttered characters, the number of speakers, and the negative-positive index for each unit time are greater.

The calculation unit 902 may calculate a conversation score for a unit time, for example, by multiplying the sum value of the calculated number-of-characters score and the calculated number-of-speakers score by the negative-positive score. With this, it is possible to calculate a conversation score the value of which is small in the case where the number of uttered characters or the number of speakers for each unit time is large but the negative-positive index is small, for example, there are a large number of negative opinions.

The calculation unit 902 may regard at least one of the number-of-characters score, the number-of-speakers score, and negative-positive score as a conversation score for a unit time. As another alternative, the calculation unit 902 may calculate a conversation score for a unit time by multiplying the number-of-characters score or the number-of-speakers score by the negative-positive score.

The calculated conversation score for each unit time is stored, for example, in the score table 230 illustrated in FIG. 8, being associated with the minutes ID and the time. The minutes ID is the one for the message data from which the conversation scores were calculated. The time is the time (date and time) corresponding to the unit time for which the conversation score was calculated.

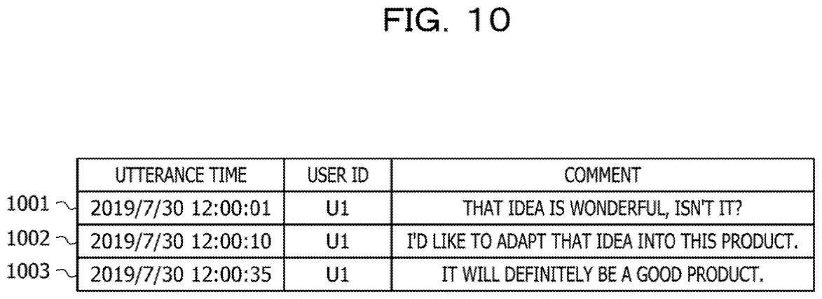

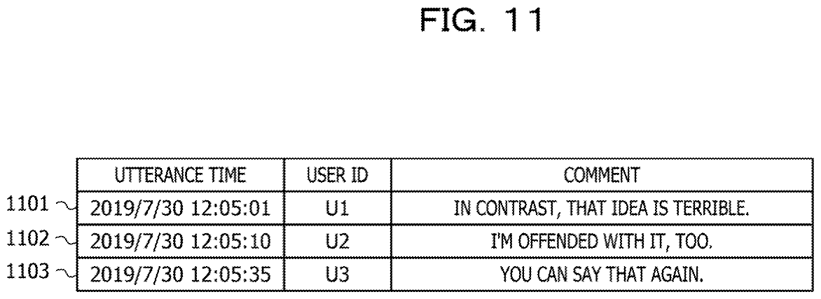

An example of calculating conversation scores is described later with reference to FIGS. 10 and 11.

The determination unit 903 determines points at which the trend of conversation changed in a specified period, based on at least one of the following information items: information on the number of uttered characters, information on the number of speakers, and information on the negative-positive index for each unit time, determined based on conversation data in the specified period. The points at which the trend of conversation changed mean, for example, points at which the subject changed, or at which the discussion became active or inactive.

Specifically, for example, the determination unit 903 determines points at which the trend of conversation changed, based on the change over time in the calculated conversation score for each unit time. More specifically, for example, the determination unit 903 creates a graph (approximate curve) representing the change over time in the conversation score based on the calculated conversation score for each unit time. The conversation score for each unit time is obtained, for example, from the score table 230.

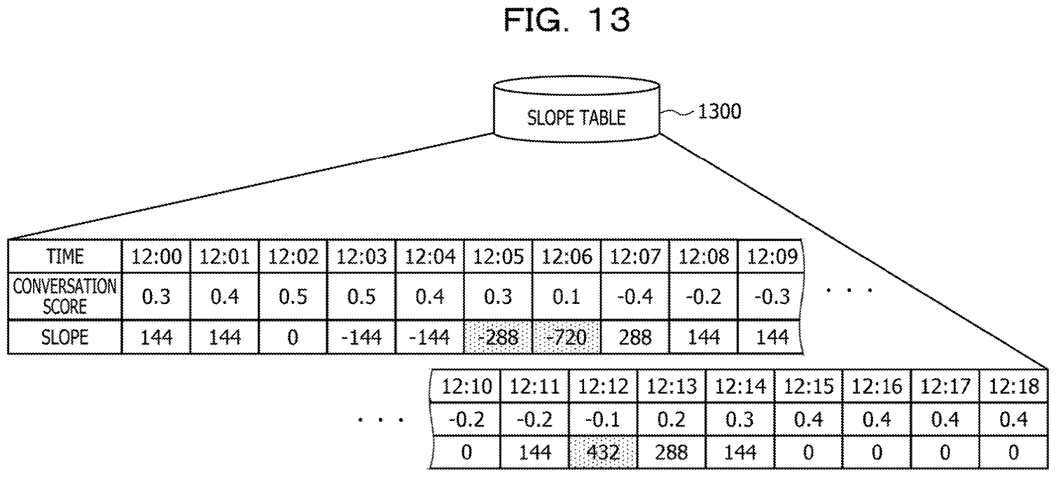

Next, the determination unit 903 calculates the slope of the created graph for each unit time. The calculated slopes are stored, for example, in a slope table 1300 illustrated in FIG. 13 described later. The determination unit 903 may determine the point (time point) at which the absolute value of the calculated slope exceeds threshold α as a point at which the trend of conversation changed. Threshold α may be set to any value.

With this, it is possible to determine points at which the change rate over time of the conversation score is large as points at which the trend of conversation changed.

The determination unit 903 may determine the time points corresponding to the top N slopes the absolute values of which are largest among the calculated slopes for each unit time as points at which the trend of conversation changed. The number N may be set to any number and is set, for example, to a value around 1 to 3.

With this, it is possible to determine the top N points at which the change rates over time of the conversation score are largest as points at which the trend of conversation changed.

Here, the determination unit 903 may exclude slopes having an absolute value smaller than threshold β from the top N slopes. Specifically, for example, the determination unit 903 determines the times corresponding to, among the top N slopes, the slopes other than the slopes having an absolute value smaller than threshold β as points at which the trend of conversation changed. Threshold β may be set to any value.

The determination unit 903 also calculates the frequency distribution of slopes based on the calculated slopes for each unit time. The determination unit 903 may determine points at which the trend of conversation changed in a specified period, based on the calculated frequency distribution. Specifically, for example, the determination unit 903 may determine time points corresponding to slopes the appearance frequencies (frequencies) of which are relatively low as points at which the trend of conversation changed, based on the frequency distribution of slopes.

More specifically, for example, the determination unit 903 determines the time points corresponding to the top K % slopes (or the top L slopes) the appearance frequencies of which are lowest as points at which the trend of conversation changed. The value K may be set to any value and is set to, for example, a value around 5 to 10. The value L may be set to any value and is set to, for example, a value around 2 to 5. With this, it is possible to determine points at which changes over time in the conversation score that are different from other portions appeared, as points at which the trend of conversation changed.

A determination example of determining points at which the trend of conversation changed based on the frequency distribution of slopes is described later with reference to FIGS. 13 to 15.

The generation unit 904 generates a summary into which the content of the conversation is summarized for each of the sections defined by dividing the specified period at the determined points, based on the conversation data in the section. Specifically, for example, the generation unit 904 classifies (groups) the message data pieces with the same minutes ID obtained from the message DB 220 into groups of message data for the sections defined by the determined points.

Next, the generation unit 904 refers to the comments (messages) of message data pieces classified for each section and generates a summary into which the content of conversation in the section is summarized. More specifically, for example, the generation unit 904 may generate minutes (summary) of each section from messages classified for the section, using an existing summarization algorithm such as LexRank.

The output unit 906 outputs a summary for each generated section. Specifically, for example, the output unit 906 may output a summary for a section, associating the summary with information for identifying the section. The information for identifying a section is, for example, information that makes it possible to determine which time period of which conference the section corresponds to.

The output unit 906 may output summaries for each section together or may output a summary for each section separately. The types of output from the output unit 906 include, for example, storing into the storage apparatuses such as the memory 402 and the disk 404, transmission by the communication I/F 405 to other computers (for example, the terminals 203), displaying on a not-illustrated display, and output for printing on a not-illustrated printer.

The output unit 906 may output information on the determined points at which the trend of conversation changed in the specified period. Specifically, for example, the output unit 906 may output information for identifying a section of the sections defined by dividing the specified period at determined points and conversation data in the section, with those associated with each other.

This makes it possible to generate a summary for each of the sections defined by dividing a specified period at points at which the trend of conversation changed, for example, using a computer different from the summary processing apparatus 201.

The creation unit 905 creates a heat map that visualizes the calculated change over time in the conversation score for each unit time. The heat map is a graph that illustrates the magnitude of the conversation score for each unit time by differentiating hue or intensity of color. Specifically, for example, the creation unit 905 may create the heat map of the change over time in the conversation score for each unit time such that the higher the conversation score, the darker the color.

The output unit 906 may output the created heat map, associating the heat map with a conversation list in which the contents that the users spoke in the specified period are organized in chronological order. At this time, the output unit 906 may output (display), for example, icons indicating that the trend of conversation changed, at the positions over the heat map corresponding to the points determined by the determination unit 903. The icon indicating that the trend of conversation changed is, for example, a division line, an arrow, or the like.

The output unit 906 may receive designation of a position over the outputted heat map and output, in response to the reception of the designation, a summary of the section corresponding to the designated position, out of the sections defined by dividing the specified period at the determined points. At this time, the output unit 906 may pop up the summary of the section corresponding to the designated position.

Specifically, for example, the output unit 906 may output the conversation list screen in which the created heat map is displayed being associated with a conversation list in which the contents that the users spoke are organized in chronological order. The conversation list screen is displayed, for example, on the display 505 of the terminal 203 (see FIG. 5) in response to a display request from the terminal 203.

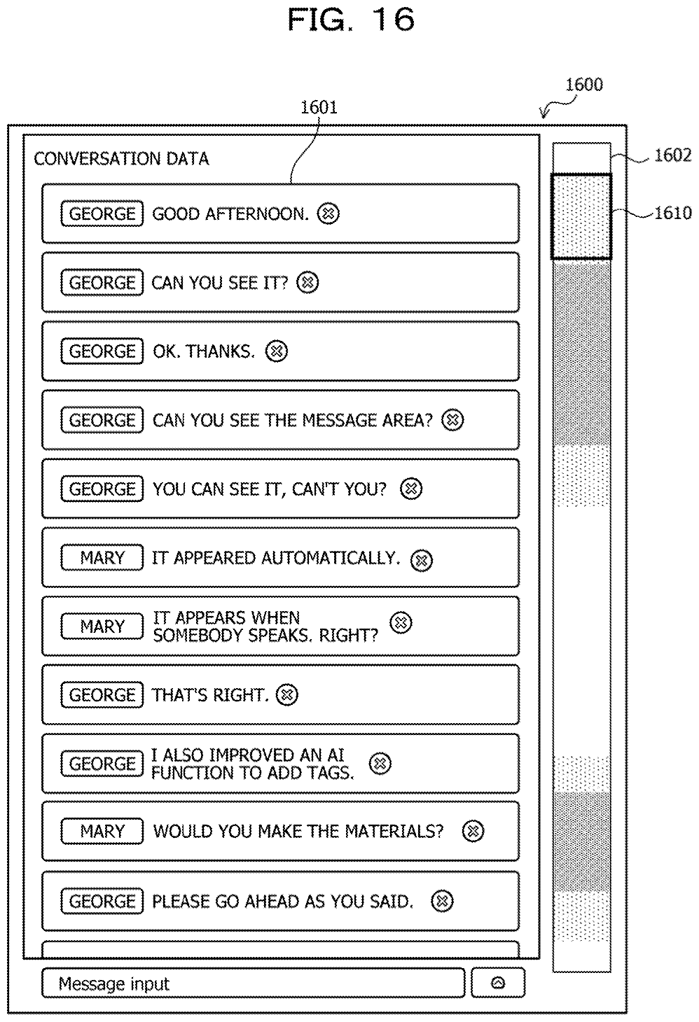

An example of the conversation list screen is described later with reference to FIGS. 16 to 18.

(Example of Calculating Conversation Scores)

Next, an example of calculating conversation scores is described with reference to FIGS. 10 and 11. Here, the unit time is set to “1 minute”, the maximum number of characters per unit time “200”, and the maximum number of users (the number of participants) “3”. Explanation here is based on a case in which the conversation score is calculated by summing the number-of-characters score and the number-of-speakers score and multiplying the sum value by the negative-positive score.

FIG. 10 is an explanatory diagram (part 1) illustrating a specific example of message data pieces for each unit time. In FIG. 10, message data pieces 1001 to 1003 are a set of message data pieces for each unit time in a conference. Here, in FIG. 10, listing the message ID and the minutes ID is omitted.

The calculation unit 902 first calculates the number of uttered characters in the comment of each of the message data pieces 1001 to 1003. The calculation unit 902 then calculates the number-of-characters score based on the calculated number of uttered characters in the comment of each of the message data pieces 1001 to 1003. The number of uttered characters in the comment of message data 1001 is “28”. The number of uttered characters in the comment of message data 1002 is “38”. The number of uttered characters in the comment of message data 1003 is “31”.

In this case, the number-of-characters score is calculated by dividing the number of uttered characters per unit time by the maximum number of characters per unit time, and the result is “0.485=(28+38+31)/200”. In case of Japanese language, the calculation unit 902 may calculate the number of uttered characters after converting kanji characters (Chinese characters) into hiragana characters (representing Japanese phonetic syllables).

Next, the calculation unit 902 calculates the number of speakers by referring to the user IDs of message data pieces 1001 to 1003 and counting the number of user IDs avoiding duplication. Because all the user IDs of message data pieces 1001 to 1003 are “U1”, the number of speakers is “1”. The calculation unit 902 then calculates the number-of-speakers score by dividing the calculated number of speakers “1” by the maximum number of users.

The number-of-speakers score is “0.33 (=1/3)”.

Next, the calculation unit 902 refers to the negative-positive-word dictionary and calculates the negative-positive degree for the comment of each of message data pieces 1001 to 1003. The calculation unit 902 then calculates the average value of the calculated negative-positive degrees for each comment as the negative-positive score (negative-positive index).

The negative-positive degree of the comment of message data 1001 is assumed to be “0.9”. The negative-positive degree of the comment of message data 1002 is assumed to be “0.5”. The negative-positive degree of the comment of message data 1003 is assumed to be “0.8”. In this case, the negative-positive score is “0.73 (=(0.9+0.5+0.8)/3)”.

The calculation unit 902 then calculates a conversation score for the unit time by summing the number-of-characters score and the number-of-speakers score and multiplying the sum value by the negative-positive score. Specifically, for example, it is possible for the calculation unit 902 to calculate the conversation score for the unit time with following formula 1.

conversation score={number-of-characters score+number-of-speakers score)/2}×negative-positive score (1)

The conversation score for the unit time is “0.30≈{0.485+0.33)/2}×0.73”.

FIG. 11 is an explanatory diagram (part 2) illustrating a specific example of message data pieces for each unit time. In FIG. 11, message data pieces 1101 to 1103 are a set of message data pieces for each unit time in a conference. Here, in FIG. 11, listing the message ID and the minutes ID is omitted.

The calculation unit 902 first calculates the number of uttered characters in the comment of each of the message data pieces 1101 to 1103. The calculation unit 902 then calculates the number-of-characters score based on the calculated number of uttered characters in the comment of each of the message data pieces 1101 to 1103. The number of uttered characters in the comment of message data 1101 is “30”. The number of uttered characters in the comment of message data 1102 is “22”. The number of uttered characters in the comment of message data 1103 is “19”.

In this case, the number-of-characters score is calculated by dividing the number of uttered characters per unit time by the maximum number of characters per unit time, and the result is “0.355=(30+22+19)/200”.

Next, the calculation unit 902 calculates the number of speakers by referring to the user IDs of message data pieces 1101 to 1103 and counting the number of user IDs avoiding duplication. Because the user IDs of message data pieces 1101 to 1103 are “U1, U2, and U3”, the number of speakers is “3”. The calculation unit 902 then calculates the number-of-speakers score by dividing the calculated number of speakers “3” by the maximum number of users.

The number-of-speakers score is “1.0 (=3/3)”.

Next, the calculation unit 902 refers to the negative-positive-word dictionary and calculates the negative-positive degree for the comment of each of message data pieces 1101 to 1103. The calculation unit 902 then calculates the average value of the calculated negative-positive degrees for each comment as the negative-positive score (negative-positive index).

The negative-positive degree of the comment of message data 1101 is assumed to be “−0.8”. The negative-positive degree of the comment of message data 1102 is assumed to be “−0.9”. The negative-positive degree of the comment of message data 1103 is assumed to be “0.1”. In this case, the negative-positive score is “−0.53 (=(−0.8−0.9+0.1)/3)”.

The calculation unit 902 then calculates a conversation score for the unit time by summing the number-of-characters score and the number-of-speakers score and multiplying the sum value by the negative-positive score. Specifically, for example, it is possible for the calculation unit 902 to calculate the conversation score for the unit time with above formula 1.

The conversation score for the unit time is “−0.36≈{0.340+1.0)/2}×(−0.53)”.

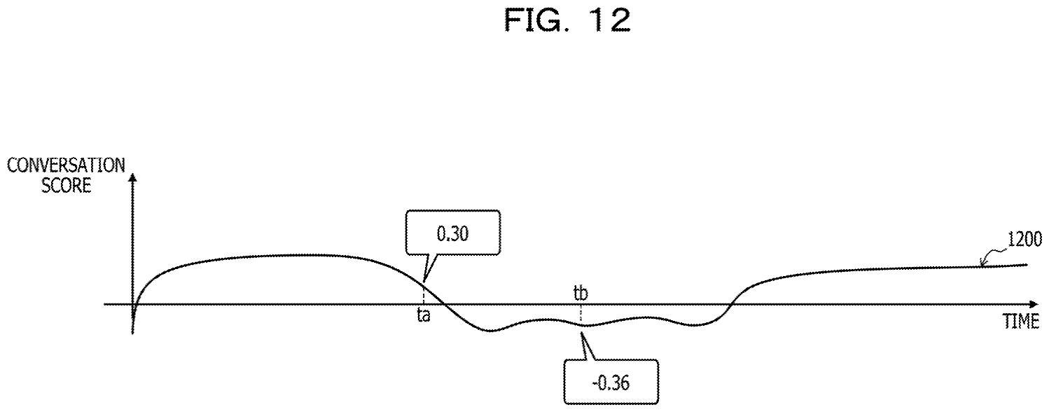

FIG. 12 is an explanatory diagram illustrating a specific example of a graph representing the change over time in the conversation score. In FIG. 12, the graph 1200 represents the change over time in the conversation score for each unit time. The conversation score “0.30” based on message data pieces 1001 to 1003 illustrated in FIG. 10 corresponds to the conversation score at time ta. The conversation score “−0.36” based on message data pieces 1101 to 1103 illustrated in FIG. 11 corresponds to the conversation score at time tb.

(Example of Determining Points at which Trend of Conversation Changed)

The following describes an example of determining points at which the trend of conversation changed, based on the frequency distribution of the slopes of a graph representing the change over time in the conversation score with reference to FIGS. 13 to 15.

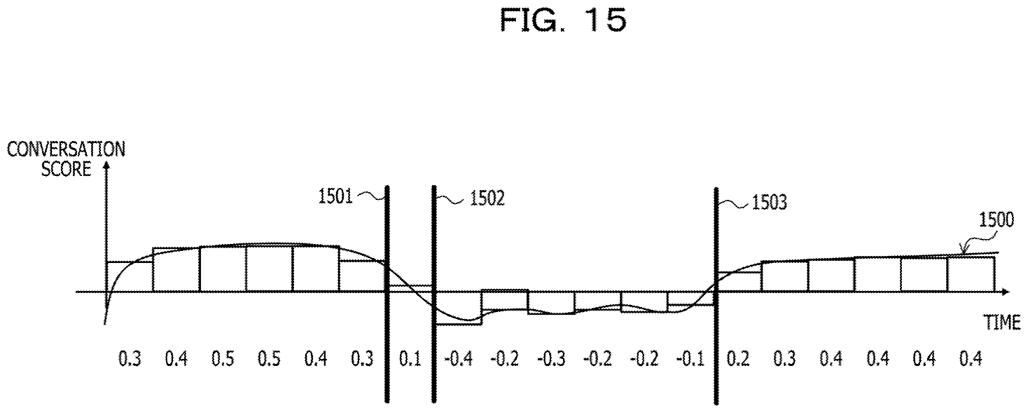

FIG. 13 is an explanatory diagram illustrating an example of the memory contents of the slope table 1300. In FIG. 13, the slope table 1300 stores, for each unit time (1 minute), the conversation score and the slope of the graph (for example, the graph 1500 illustrated in FIG. 15 described later) representing the change over time in the conversation score.

It is possible to calculate the slope with the formula “y=ax+b” which expresses the straight line passing through two points on a graph representing the change over time in the conversation score. The symbol y represents the conversation score. The symbol x represent time.

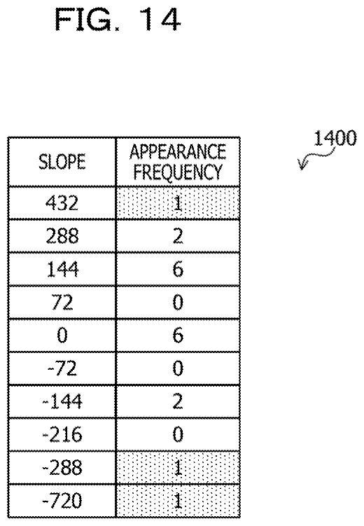

For example, the determination unit 903 calculates the frequency distribution of slopes, referring to the slope table 1300. Specifically, for example, the determination unit 903 calculates the appearance frequency for each slope, referring to the slope table 1300 and creates an appearance frequency table 1400 as illustrated in FIG. 14.

FIG. 14 is an explanatory diagram illustrating an example of the memory contents of the appearance frequency table 1400. In FIG. 14, the appearance frequency table 1400 stores appearance frequencies by slope. The appearance frequencies by slope are expressed by the number of appearances.

For example, the determination unit 903 determines slopes the appearance frequencies of which are relatively low, referring to the appearance frequency table 1400. Specifically, for example, the determination unit 903 determine the top around 5 to 10% slopes the appearance frequencies of which are lower, referring to the appearance frequency table 1400. Here, slopes with an appearance frequency of “0” are excluded.

The appearance frequency of the slopes “432”, “−288”, and “−720” is “1”, which is the lowest. In this case, the determination unit 903 selects the slopes “432”, “−288”, and “−720”. Since there are multiple slopes that have the lowest appearance frequency, the top 18% slopes are selected.

The determination unit 903 determines the times corresponding to the selected slopes “432”, “−288”, and “−720” as points at which the trend of conversation changed. Specifically, for example, the determination unit 903 refers to the slope table 1300 to determine the times corresponding to the slopes “432”, “−288”, and “−720” as points at which the trend of conversation changed.

FIG. 15 is an explanatory diagram illustrating an example of determining points at which the trend of conversation changed. In FIG. 15, the graph 1500 indicates the change over time in the conversation score for each unit time, and this corresponds to the slope table 1300 illustrated in FIG. 13.

The time corresponding to line-segment 1501 is time “12:05” corresponding to the slope “−288”. The time corresponding to line-segment 1502 is time “12:06” corresponding to the slope “−720”. The time corresponding to line-segment 1503 is time “12:12” corresponding to the slope “432”.

For example, times “12:05”, “12:06”, and “12:12” are determined as points at which the trend of conversation changed.

(Example of Conversation List Screen)

The following describes an example of a conversation list screen including a heat map indicating the change over time in the conversation score for each unit time with reference to FIGS. 16 to 18.

FIG. 16 is an explanatory diagram (part 1) illustrating an example of a conversation list screen. In FIG. 16, the conversation list screen 1600 is an example of a browser screen displaying a conversation list 1601 in which the contents remarked by each user are organized in chronological order. The conversation list screen 1600 is generated, for example, based on the message data pieces corresponding to the minutes ID included in a display request from the terminal 203.

On the conversation list screen 1600, a heat map 1602 is displayed being associated with the conversation list 1601. The heat map 1602 is for visualizing the change over time in the conversation score for each unit time. In the heat map 1602, portions having higher conversation scores are displayed with darker colors.

On the conversation list screen 1600, for example, when the user moves a highlight marker 1610 which is the bold rectangular frame superimposed on the heat map 1602 by the user's input operation on the input device 506 (see FIG. 5), the content of remarks in the time period corresponding to the position of the highlight marker 1610 is displayed in the conversation list 1601.

The conversation list screen 1600 allows the user to switch the comments displayed in the conversation list 1601 while the user is checking the change over time in the conversation score for each unit time, referring to the heat map 1602. For example, it is possible for the user to judge that the darker the color of a portion on the heat map 1602, the more positive opinions the portion include, and the discussion took place actively in the portion.

This allows the user to intuitively determine points at which conversation was lively, points at which the subject changed, or the like and helps the user find a specific comment among a batch of comments.

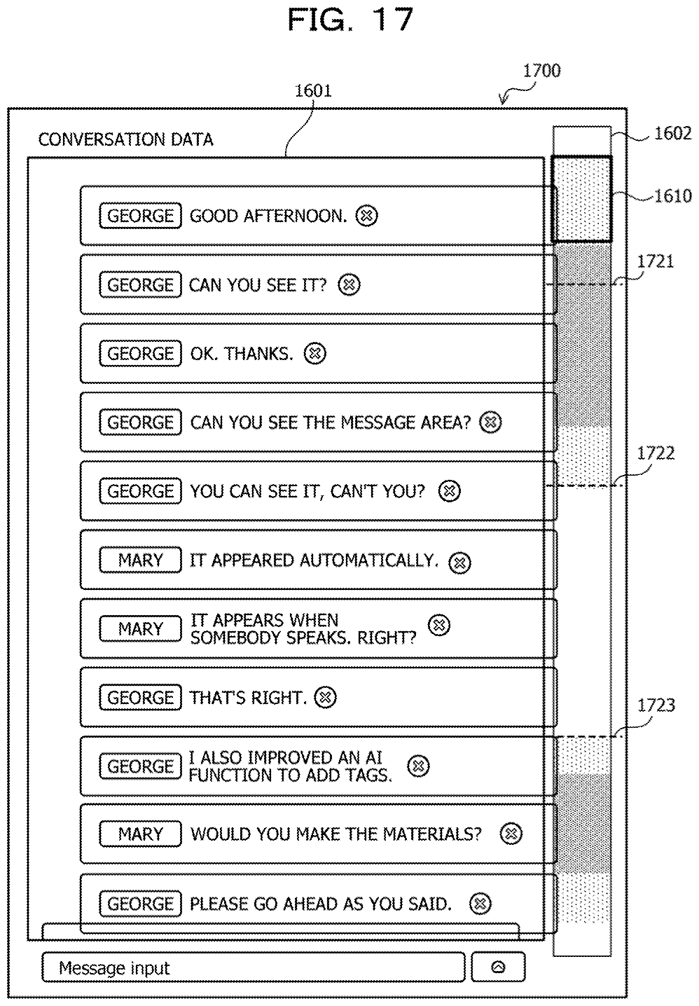

The following describes, with reference to FIG. 17, a case of displaying an icon indicating that the trend of conversation changed over a heat map for visualizing the change over time in the conversation score for each unit time on the conversation list screen.

FIG. 17 is an explanatory diagram (part 2) illustrating an example of a conversation list screen. In FIG. 17, the conversation list screen 1700 is an example of a browser screen displaying a conversation list 1601 in which the contents remarked by each user are organized in chronological order. On the conversation list screen 1700, a heat map 1602 is displayed being associated with the conversation list 1601.

On the heat map 1602, division lines 1721 to 1723 are superimposed. The division lines 1721 to 1723 are an example of icons indicating points at which the trend of conversation changed. The conversation list screen 1700 allows the user to easily determine points at which the subject changed, or points at which the discussion was active, or the like in a conference.

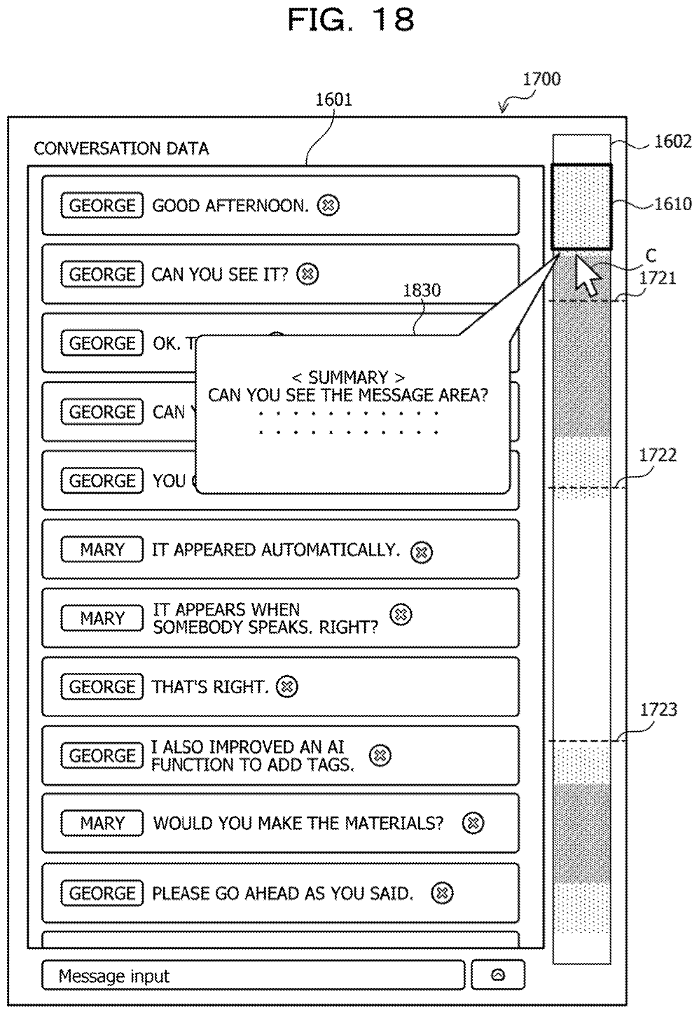

On the conversation list screen 1700, when the user moves the cursor C and designates a position on the heat map 1602 by the user's input operation on the input device 506, the summary of the section corresponding to the designated position is displayed as illustrated in FIG. 18.

FIG. 18 is an explanatory diagram (part 3) illustrating an example of a conversation list screen. In FIG. 18, the summary 1830 of the section corresponding to the position designated by the cursor C on the heat map 1602 is displayed on the conversation list screen 1700. The summary 1830 allows the user to easily understand what kind of discussion took place in an early part of the conference.

(Message Processing Procedure in Terminal 203)

The following describes message processing procedure in the terminal 203.

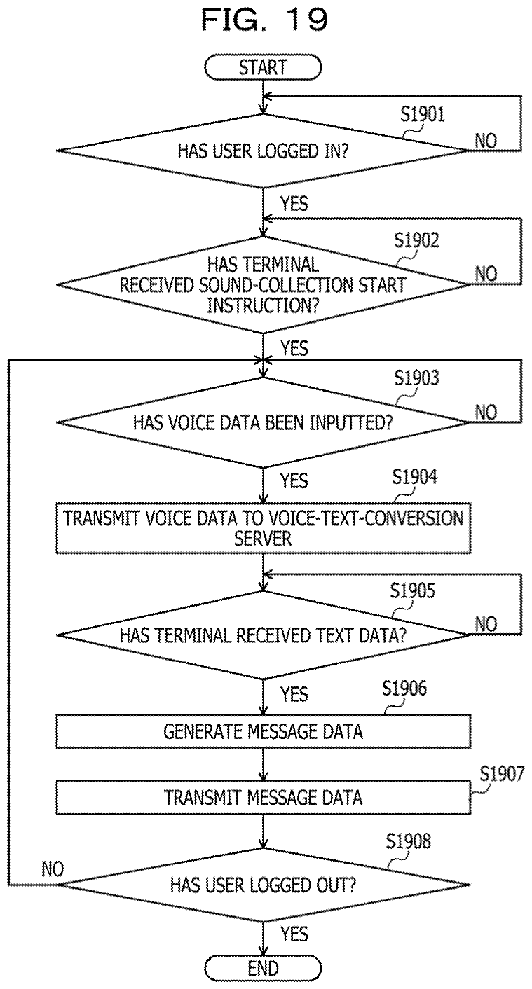

FIG. 19 is a flowchart illustrating an example of message processing procedure in the terminal 203. In the flowchart of FIG. 19, the terminal 203 first determines whether a user has logged in to the application for a Web conference (step S1901). The login process is performed, for example, using the user ID and the password.

The terminal 203 waits for the user to log in (step S1901: No). When the user logs in (step S1901: Yes), the terminal 203 determines whether the terminal 203 has received a sound-collection start instruction (step S1902). The sound-collection start instruction is inputted, for example, by the user's input operation of pressing down a sound-collection button on the terminal 203.

The terminal 203 waits until the terminal 203 receives a sound-collection start instruction (step S1902: No). When the terminal 203 receives a sound-collection start instruction (step S1902: Yes), the terminal 203 determines whether the microphone 503 has received input of the user's voice data (uttered voice data) (step S1903).

The terminal 203 waits for input of the voice data (step S1903: No). When the terminal 203 receives input of the voice data (step S1903: Yes), the terminal 203 transmits the inputted voice data to the voice-text-conversion server 202 (step S1904).

Next, the terminal 203 determines whether the terminal 203 has received text data converted from the voice data from the voice-text-conversion server 202 (step S1905). The terminal 203 waits until the terminal 203 receives the text data (step S1905: No). When the terminal 203 receives the text data (step S1905: Yes), the terminal 203 generates message data MD including the received text data (step S1906).

Next, the terminal 203 transmits the generated message data MD to the summary processing apparatus 201 (step S1907). When the terminal 203 receives a message object from the summary processing apparatus 201, the terminal 203 renders the received message object on the message screen (for example, see FIG. 3).

Next, the terminal 203 determines whether the user has logged out (step S1908). When the user has not logged out (step S1908: No), the terminal 203 returns to step S1903. On the other hand, in the case where the user has logged out (step S1908: Yes), the terminal 203 ends a series of processes according this flowchart.

With this, every time the user's voice data (uttered voice data) is inputted into the microphone 503, it is possible to upload message data MD including the text data into which the voice data is converted to the summary processing apparatus 201.

(Message-Registration Processing Procedure in Summary Processing Apparatus 201)

The following describes message-registration processing procedure in the summary processing apparatus 201.

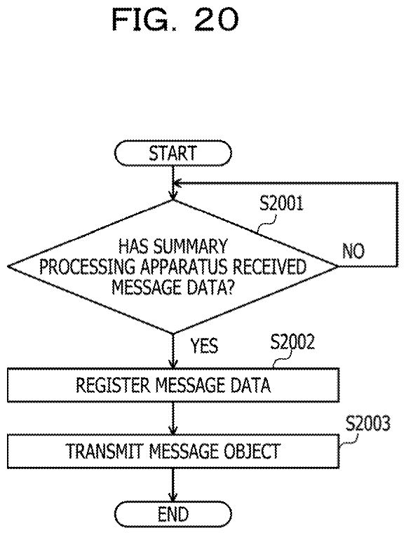

FIG. 20 is a flowchart illustrating an example of the message-registration processing procedure in the summary processing apparatus 201. In the flowchart of FIG. 20, the summary processing apparatus 201 first determines whether the summary processing apparatus 201 has received message data MD from the terminal 203 (step S2001). The summary processing apparatus 201 waits until the summary processing apparatus 201 receives message data MD (step S2001: No).

When the summary processing apparatus 201 receives message data MD (step S2001: Yes), the summary processing apparatus 201 registers the received message data MD (message ID, minutes ID, user ID, utterance time, comment) in the message DB 220 (step S2002).

The summary processing apparatus 201 next transmits a message object for rendering corresponding to the received message data MD to the terminals 203 that are currently logged in to the application for the Web conference (step S2003) and ends a series of processes according to this flowchart.

With this, it is possible to register the message data MD uploaded from the terminal 203 into the message DB 220 and also possible to make logged-in terminals 203 render the comment included in the message data MD.

(Summary-Generation Processing Procedure in Summary Processing Apparatus 201)

The following describes summary-generation processing procedure in the summary processing apparatus 201.

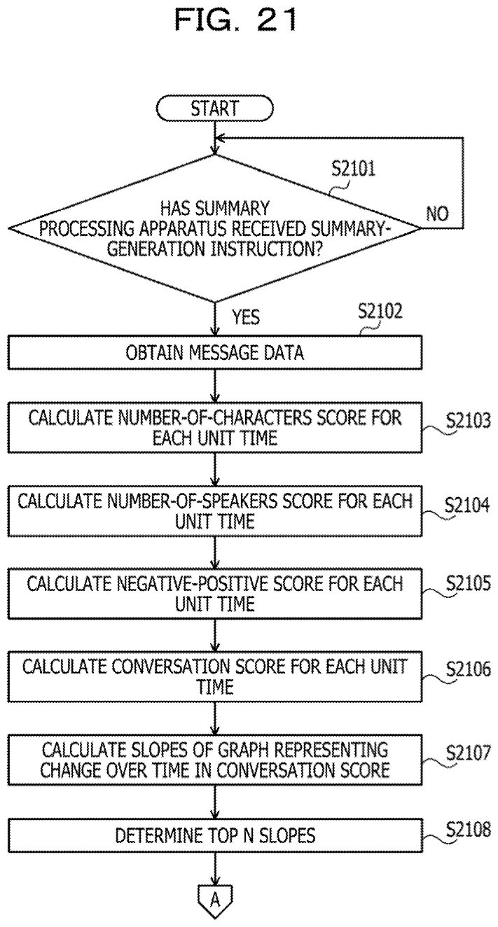

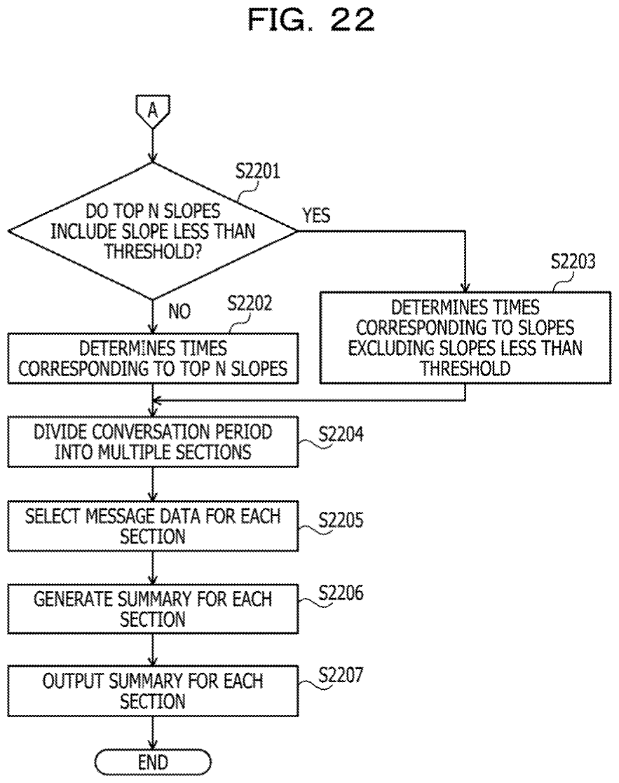

FIGS. 21 and 22 are flowcharts illustrating an example of summary-generation processing procedure in the summary processing apparatus 201. In the flowchart of FIG. 21, the summary processing apparatus 201 first determines whether the summary processing apparatus 201 has received a summary-generation instruction from a terminal 203 (step S2101). The summary-generation instruction is for requesting generation of a summary of the content of discussion in a conference, a meeting, or the like.

The summary processing apparatus 201 waits until the summary processing apparatus 201 receives a summary-generation instruction (step S2101: No). When the summary processing apparatus 201 receives a summary-generation instruction (step S2101: Yes), the summary processing apparatus 201 obtains message data pieces corresponding to the minutes ID included in the received summary-generation instruction from the message DB 220 (step S2102).

The summary processing apparatus 201 next calculates the number-of-characters score for each unit time based on a set of obtained message data pieces (step S2103). The summary processing apparatus 201 next calculates the number-of-speakers score for each unit time based on the obtained message data pieces (step S2104).

The summary processing apparatus 201 next refers to the negative-positive-word dictionary and calculates the negative-positive score for each unit time based on the obtained message data pieces (step S2105). The summary processing apparatus 201 then calculates the conversation score for each unit time based on the number-of-characters score, the number-of-speakers score, and the negative-positive score calculated for each unit time (step S2106).

The summary processing apparatus 201 next calculates, for each unit time, the slope of a graph representing the change over time in the calculated conversation score for each unit time (step S2107). The summary processing apparatus 201 then determines the top N slopes the absolute values of which are largest among the calculated slopes for each unit time (step S2108) and moves to step S2201 illustrated in FIG. 22.

In the flowchart of FIG. 22, the summary processing apparatus 201 first determines whether there are slopes the absolute values of which are less than a threshold among the determined top N slopes (step S2201). If there is no slope less than the threshold (step S2201: No), the summary processing apparatus 201 determines the times corresponding to the determined top N slopes as points at which the trend of conversation changed (step S2202) and moves to step S2204.

On the other hand, if there are slopes less than the threshold (step S2201: Yes), the summary processing apparatus 201 determines the times corresponding to the slopes except the slopes less than the threshold, out of the determined top N slopes, as points at which the trend of conversation changed (step S2203). The summary processing apparatus 201 then divides the conversation period from the start to the end of the conversation at the determined points (times) into multiple sections (step S2204).

The start time and the end time of the conversation period (specified period) is determined, for example, from the utterance times of the message data pieces obtained at step S2102.

The summary processing apparatus 201 next selects message data pieces for each division section from the set of the obtained message data pieces (step S2205). Next, the summary processing apparatus 201 generates a summary into which the content of conversation for each section is summarized based on the selected message data pieces for each section (step S2206).

The summary processing apparatus 201 then outputs summaries generated by section to the terminal 203 that transmitted the summary-generation instruction to the summary processing apparatus 201 (step S2207) and ends a series of processes according to this flowchart.

With this, it is possible to generate, for each of the sections defined by dividing the conversation period at points at which the trend of conversation changed, a summary into which the content of conversation in the section is summarized.

(Processing Procedure for Displaying Messages in List Form)

The following describes processing procedure for displaying messages in list form in the summary processing apparatus 201.

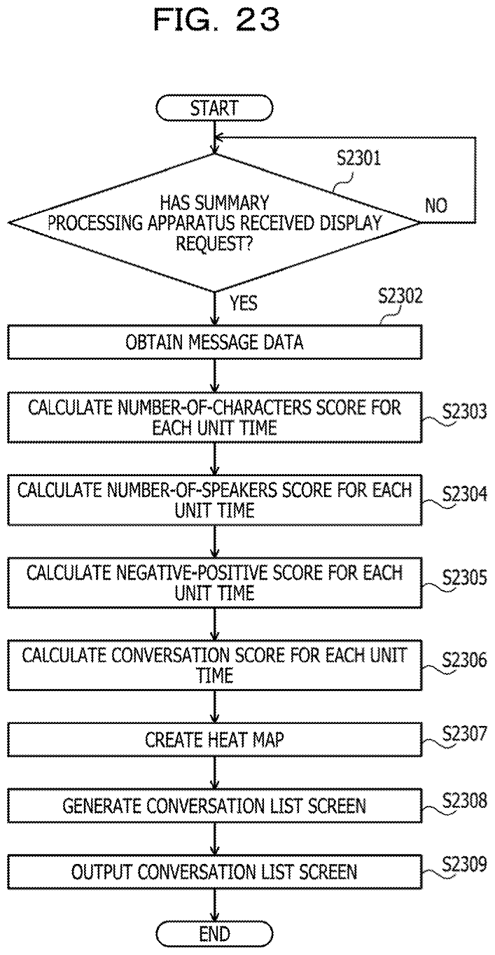

FIG. 23 is a flowchart illustrating an example of processing procedure for displaying messages in list form in the summary processing apparatus 201. In the flowchart of FIG. 23, the summary processing apparatus 201 first determines whether the summary processing apparatus 201 has received a display request from a terminal 203 (step S2301). The display request is for requesting display of the content of discussion in a conference, a meeting, or the like in list form.

The summary processing apparatus 201 waits until the summary processing apparatus 201 receives a display request (step S2301: No). When the summary processing apparatus 201 receives a display request (step S2301: Yes), the summary processing apparatus 201 obtains message data pieces corresponding to the minutes ID included in the received display request from the message DB 220 (step S2302).

Next, the summary processing apparatus 201 calculates the number-of-characters score for each unit time based on a set of the obtained message data pieces (step S2303). The summary processing apparatus 201 next calculates the number-of-speakers score for each unit time based on the obtained message data pieces (step S2304).

The summary processing apparatus 201 next refers to the negative-positive-word dictionary and calculates the negative-positive score for each unit time based on the obtained message data pieces (step S2305). The summary processing apparatus 201 then calculates the conversation score for each unit time based on the number-of-characters score, the number-of-speakers score, and the negative-positive score calculated for each unit time (step S2306).

The summary processing apparatus 201 next creates a heat map that visualizes the calculated change over time in the conversation score for each unit time (step S2307). Based on the obtained set of message data pieces, the summary processing apparatus 201 next generates screen information on the conversation list screen in which the created heat map is displayed being associated with the conversation list in which the contents remarked by each user are organized in chronological order (step S2308).

The summary processing apparatus 201 then outputs the generated screen information on the conversation list screen to the terminal 203 that transmitted the display request to the summary processing apparatus 201 (step S2309) and ends a series of processes according to this flowchart.

With this, it is possible to display a heat map that visualizes the change over time in the conversation score for each unit time, associating the heat map with a conversation list in which the contents remarked by each user are organized in chronological order. The summary processing apparatus 201 may display icons indicating points at which the trend of conversation changed over the heat map in the conversation list screen. The summary processing apparatus 201 may receive designation of a position over the heat map in the conversation list screen and output, in response to the reception of the designation, a summary of the section corresponding to the designated position.

As has been described above, the summary processing apparatus 201 according to the embodiment obtains conversation data indicating the content that each user spoke in a specified period and determines points at which the trend of conversation changed in the specified period based on at least one of the information items: information on the number of uttered characters, information on the number of speakers, and information on the negative-positive index determined for each unit time based on the obtained conversation data.

With this, it is possible to determine points at which the content of conversation (for example, subject, mood, or the like) changed in a conference, a meeting, or the like.

The summary processing apparatus 201 is capable of generating, for each of the sections defined by dividing a specified period at determined points, a summary into which the content of conversation is summarized, based on conversation data for the section and outputting the generated summary for each section.

With this, it is possible to generate a summary for each of the sections defined by the points at which the content of conversation changed even if multiple subjects are discussed in a conference or the like, or the mood of conversation changed, and thus it is possible to avoid the situation in which information on important topics is lost.

The summary processing apparatus 201 is capable of determining points at which the trend of conversation changed based on at least one of the following information items: the change over time in the number of uttered characters, the change over time in the number of speakers, and the change over time in the negative-positive index for each unit time.

With this, it is possible to determine times when the number of uttered characters per unit time or the number of speakers changed greatly and which is thus regarded as the times when the discussion became active or inactive, or times when the number of positive (or negative) opinions increased and which is thus regarded as the times when the mood of conversation or the subject changed, as points at which the trend of conversation changed.

The summary processing apparatus 201 is capable of calculating a conversation score for each unit time based on information on the number of uttered characters for each unit time, information on the number of speakers, and information on the negative-positive index. The summary processing apparatus 201 is capable of determining points at which the trend of conversation changed based on the calculated change over time in the conversation score for each unit time.

With this, it is possible to comprehensively evaluate changes over time in the number of uttered characters, the number of speakers, and the negative-positive index for each unit time and determine points at which the trend of conversation changed.

The summary processing apparatus 201 is capable of calculating a conversation score for each unit time by summing the number-of-characters score (a first score) based on the number of uttered characters for each unit time, the number-of-speakers score (a second score) based on the number of speakers for each unit time, and the negative-positive score (a third score) for each unit time.

With this, it is possible to calculate conversation scores in which when the number of uttered characters per unit time, the number of speakers, and the negative-positive index are greater, the conversation score is higher.

The summary processing apparatus 201 is capable of calculating a conversation score for each unit time by summing the number-of-characters score for the unit time (the first score) and the number-of-speakers score (the second score) for the unit time and then multiplying the sum value by the negative-positive score (the third score) for the unit time.

With this, it is possible to calculate conversation scores that change greatly depending on which opinions are dominant, positive ones or negative ones. For example, it is possible to calculate the conversation score with the negative-positive score prioritized among the number-of-characters score, the number-of-speakers score, and negative-positive score. With this, for example, it is possible to calculate a conversation score that is a small value (for example, a negative value) when negative opinions are dominant even if many users were involved actively in a discussion.

The summary processing apparatus 201 is capable of determining points at which the trend of conversation changed based on the frequency distribution of slopes of a graph representing the calculated change over time in the conversation score for each unit time. For example, the summary processing apparatus 201 determines time points corresponding to the top K % slopes the appearance frequencies of which are lower, as points at which the trend of conversation changed.

With this, it is possible to determine points at which the change over time in the conversation score is different from the other points, as points at which the trend of conversation changed. Thus, for example, even in a case where discussion goes lively and then inactive, and this situation repeats on one subject, it is possible to accurately determine times at which the subject changes.

The summary processing apparatus 201 is capable of determining time points corresponding to the top N slopes the absolute values of which are largest among the slopes of a graph representing the calculated change over time in the conversation score for each unit time, as points at which the trend of conversation changed. The summary processing apparatus 201 is also capable of excluding the slopes the absolute values of which are less than threshold β among the top N slopes.

With this, it is possible to determine points at which the change over time in the conversation score is different from the other points, as points at which the trend of conversation changed. Since points not exhibiting changes larger than threshold β are not selected even if the absolute values of the slopes at the points are relatively large, it possible, for example, to avoid a situation in which even though the subject does not change in one conference, the period is divided into multiple sections.

The summary processing apparatus 201 is capable of creating a heat map that visualizes the change over time in the conversation score for each unit time and outputting the created heat map, associating the heat map with a conversation list in which the contents remarked by each user are organized in chronological order in a specified period.

With this, when a user views the content (comments) that each user spoke in a conference or the like, it is possible for the user to intuitively determine points at which conversation was lively, points at which the subject changed, or the like and easily find a specific comment among a batch of comments.

The summary processing apparatus 201 is capable of, when outputting a heat map, outputting icons indicating that the trend of conversation changed at positions over the heat map corresponding to the determined points at which the trend of conversation changed.

This makes it easy to determine points at which the subject changed, points at which discussion was active, or the like in a conference or the like.

The summary processing apparatus 201 is capable of receiving designation of a position over the outputted heat map and outputting, in response to the reception of the designation, a summary of the section corresponding to the designated position, out of the sections defined by the determined points at which the trend of conversation changed.

With this, a simple operation of designating a position over the heat map allows the user to view a summary into which the content of conversation is summarized for the section corresponding to the position, and this improves convenience of the user.

The information processing method described in this embodiment may be realized by executing a program prepared in advance on a computer such as a personal computer or a workstation. The information processing program described according to the present embodiment is recorded on a computer-readable recording medium such as a hard disk, a flexible disk, the CD-ROM, the DVD, or the USB memory and is executed as a result of being read from the recording medium by a computer. The information processing program may also be distributed via a network such as the Internet.

The information processing apparatus 101 and the summary processing apparatus 201 described in the embodiment may also be achieved with an IC for a specific application, such as a standard cell or a structured application-specific integrated circuit (ASIC), or with a programmable logic device (PLD), such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium having stored therein an information processing program for causing a computer to execute a process comprising:
obtaining conversation data indicating content that users communicate in a specified period of time, the specified period of time including a plurality of unit time periods; and
determining at least one point at which a trend of conversation has changed in the specified period, based on at least one of number of uttered words or characters, number of speakers, and frequency of utterances of positive words or negative words, which are determined for each of the plurality of unit time periods based on the obtained conversation data.

2. The storage medium according to claim 1, the process further comprising:
generating, for each of sections defined by dividing the specified period at the at least one determined point, a summary into which the content of conversation is summarized based on conversation data for a corresponding section.

3. The storage medium according to claim 1, wherein
in the determining, the at least one point is determined based on at least one of change over time in the number of uttered words or characters for each unit time period, change over time in the number of speakers for each unit time period, and change over time in the frequency of utterances of positive words or negative words for each unit time period.

4. The storage medium according to claim 2, wherein the process further comprising:
calculating a conversation score for each unit time period based on the number of uttered words or characters for each unit time period, the number of speakers for each unit time period, and the frequency of utterances of positive words or negative words for each unit time period, wherein
in the determining, the at least point is determined based on change over time in the calculated conversation score for each unit time period.

5. The storage medium according to claim 4, wherein
in the calculating, the conversation score for each unit time period is calculated by summing a first score based on the number of uttered words or characters for each unit time period, a second score based on the number of speakers for each unit time period, and a third score based on the frequency of utterances of positive words or negative words for each unit time period.

6. The storage medium according to claim 4, wherein
in the calculating, the conversation score for each unit time period is calculated by summing a first score based on the number of uttered words or characters for each unit time period and a second score based on the number of speakers for each unit time period and multiplying the sum value by a third score based on the frequency of utterances of positive words or negative words for each unit time period.

7. The storage medium according to claim 4, wherein
in the determining, the at least one point is determined based on a frequency distribution of slopes of a graph representing change over time in the calculated conversation score for each unit time period.

8. The storage medium according to claim 7, wherein
in the determining, time points corresponding to the slopes included in a specified proportion, in which the appearance frequencies are lowest of all the slopes, are determined as the at least one point, based on the frequency distribution.

9. The storage medium according to claim 4, wherein
in the determining, time points corresponding to a specified number of slopes, absolute values of which are largest among the slopes of a graph representing change over time in the calculated conversation score for each unit time period, are determined as the at least one time point.

10. The storage medium according to claim 2, wherein the process further comprising:
outputting the generated summary for each section.

11. The storage medium according to claim 4, wherein the process further comprising:
creating a heat map that visualizes the change over time in the conversation score for each unit time period; and
outputting the generated heat map, associating the heat map with a conversation list in which the contents remarked by each user in the specified period are organized in chronological order.

12. The storage medium according to claim 11, wherein
in the outputting, an icon indicating that the trend of conversation changed is added at a position over the heat map corresponding to the determined at least one point.

13. The storage medium according to claim 11, wherein the process further comprising:
receiving a designation of a position over the outputted heat map and outputting, in response to the reception of the designation, a summary for the section corresponding to the position.

14. A computer-implemented method for causing a computer to execute a process comprising:
obtaining conversation data indicating content that users communicate in a specified period of time, the specified period of time including a plurality of unit time periods; and
determining at least one point at which a trend of conversation has changed in the specified period, based on at least one of number of uttered words or characters, number of speakers, and frequency of utterances of positive words or negative words, which are determined for each of the plurality of unit time periods based on the obtained conversation data.

15. An information processing apparatus comprising:
a memory, and
a processor coupled to the memory and configured to:
obtain conversation data indicating content that users spoke in a specified period of time, the specified period of time including a plurality of unit time periods; and
determine at least one point at which a trend of conversation has changed in the specified period, based on at least one of number of uttered words or characters, number of speakers, and frequency of utterances of positive words or negative words, which are determined for each of the plurality of unit time periods based on the obtained conversation data.

16. The information processing apparatus according to claim 15, the processor further configured to:
generate, for each of sections defined by dividing the specified period at the at least one determined point, a summary into which the content of conversation is summarized based on conversation data for a corresponding section.

17. The information processing apparatus according to claim 15, wherein
the processor determines, the at least one point based on at least one of change over time in the number of uttered words or characters for each unit time period, change over time in the number of speakers for each unit time period, and change over time in the frequency of utterances of positive words or negative words for each unit time period.

18. The information processing apparatus according to claim 16, wherein the processor is further configured to:
calculate a conversation score for each unit time period based on the number of uttered words or characters for each unit time period, the number of speakers for each unit time period, and the frequency of utterances of positive words or negative words for each unit time period, and
determines the at least point based on change over time in the calculated conversation score for each unit time period.

19. The information processing apparatus according to claim 18, wherein
the processor calculates the conversation score for each unit time period by summing a first score based on the number of uttered words or characters for each unit time period, a second score based on the number of speakers for each unit time period, and a third score based on the frequency of utterances of positive words or negative words for each unit time period.

20. The information processing apparatus according to claim 18, wherein
the processor calculates the conversation score for each unit time period by summing a first score based on the number of uttered words or characters for each unit time period and a second score based on the number of speakers for each unit time period and multiplying the sum value by a third score based on the frequency of utterances of positive words or negative words for each unit time period.
